(19) United States
(12) Patent Application Publication
(10) Pub. No.: US 2023/0012258 A1
(43) Pub. Date: Jan. 12, 2023

(54) WASTE PROCESSING SYSTEM

(71) Applicant: Advanced Biofuel Solutions Ltd., Swindon (GB)

(72) Inventors: Kevin Griggs, Swindon (GB); Richard Taylor, Swindon (GB)

(73) Assignee: Advanced Biofuel Solutions Ltd., Swindon (GB)

(21) Appl. No.: 17/801,229

(22) PCT Filed: Feb. 19, 2021
(86) PCT No.: PCT/GB2021/050412

§ 371 Date: Aug. 19, 2022

(30) Foreign Application Priority Data
Feb. 21, 2020 (GB) 2002424.6

(51) Int. Cl. C10J 3/72; B09B 3/40; C10J 3/48; C10K 3/00; F23G 5/027; F23G 5/08; F23G 5/16; F23G 5/30

(52) U.S. Cl. CPC C10J 3/721; B09B 3/40; C10J 3/482; C10J 3/723; C10K 3/005; F23G 5/027; F23G 5/085; F23G 5/16; F23G 5/30; C10J 2300/0946; C10J 2300/0916; C10J 2300/1238; C10J 2300/0959

(57) ABSTRACT

The invention relates to an apparatus for producing syngas, typically from municipal waste. In particular, a gasifier is used in combination with a plasma furnace. The system is configured so that non-airborne char generated in the gasifier is removed from the system prior to delivery to the plasma furnace. This enhances the energy efficiency of the system whilst still yielding excellent yields of syngas.

### FIELD OF INVENTION

The invention relates to an apparatus for producing syngas from feedstocks and a method of producing syngas from said feedstocks.

### BACKGROUND

Various feedstocks have been used for a variety of processes for many years in order to produce biofuel and generate energy, especially feedstocks with otherwise low commercial value or undesirable characteristics. The waste industry, agriculture and industrial manufacturing are all good examples of sectors that generate a regular stream of material which can serve as feedstocks in such processes. It is advantageous to make use of such feedstocks for many reasons, not least because most feedstock materials, if not employed in such processes or recycled, are sent to landfill. Much of the feedstocks passing through the national waste processing systems of the world are rich in useful materials, such as hydrocarbons and carbonaceous materials. This often makes such feedstocks an energy rich fuel and/or an economical feedstock from which to synthesise more versatile compounds. However, there are a number of difficulties associated with using feedstocks drawn from such industries.

Firstly, the composition of some feedstocks is often varied. This means preliminary sorting is often required to remove problem contaminants which could otherwise interfere with downstream processing. As an example, conventional household waste is not typically homogeneous and so often must be physically, and sometimes chemically, pre-treated before it can be employed as a feedstock or fuel source. Even if harmful contaminants are removed, the ratio and selection of chemicals present in such a feedstock is often very varied. The composition of feedstocks derived primarily from agriculture (usually high in biomass) is again very different to municipal solid waste. Indeed, even different batches of municipal solid waste can contain very different material compositions. This means that the concentration of different reagents within the feedstock can vary greatly. Consequently, it is frequently challenging to process such feedstocks using standard conditions, especially if multiple downstream processes are required.

Attempts have been made in the past to employ feedstocks of the kind described above either as a direct fuel source (to be used in incinerators) or as a starting material for reactions that produce alternative, more versatile fuels. These fuels could be combustible small chain hydrocarbon gases (such as methane, ethane and propane), hydrogen gas, small chain alcohols, synthetic fuels, syngas, longer chain hydrocarbons or combinations thereof.

A common technology that is used to convert such feedstocks into more useful materials are gasifiers. A gasifier uses high temperatures and a controlled environmental to break down complex feedstocks without directly combusting the reagents. An oxygen source (normally air) is administered to the gasifier and hydrocarbons present in the material of the feedstock are broken down into carbon monoxide, carbon dioxide and hydrogen.

Another technology that has recently been employed in combination with gasifiers, especially in the production of syngas, are plasma furnaces. Plasma furnaces generate a high energy electric arc that can be used to heat up reactants and provoke the breakdown of complex materials. Plasma furnaces are used in a wide range of industrial chemical processing techniques including the manufacturing of ferroalloys, carbides and phosphorus.

Various systems have been developed to make best use of different feedstocks, using these kinds of technology. For example, EP 2 633 033 B1 discloses a waste processing arrangement designed to convert biomass feedstocks into syngas. The gasifier uses high temperature conditions to generate syngas.

U.S. Pat. No. 8,974,555 B2 describes a plasma torch arrangement used in conjunction with a gasifier to maximise the amount of useable syngas produced from a waste feedstock. Gases leaving the gasifier are passed over a plasma torch which heats up and breaks down those long chain hydrocarbons not already broken down by the gasifier.

WO 99/58627 discloses a process for generating syngas using a high temperature gasifier in combination with a high powered plasma furnace. This allows almost all of the waste feedstock to be converted into either carbon black, hydrogen gas or syngas.

GB 2 423 079 A describes a process for converting waste into syngas using a gasifier and a plasma furnace. All gases and char produced in the gasifier are delivered to the plasma furnace in order to maximise the amount of syngas produced.

EP 2 025 073 describes a process involving a downdraft gasifier wherein the products of the gasifier are delivered to a plasma furnace to ensure substantially all of the waste material is converted into a useable syngas.

However, despite numerous attempts, there is still a desire to produce an efficient system which produces syngas from complex feedstocks in a cost effective manner. Moreover, it is desirable for the system to operate in a continuous fashion and produce a steady stream of high quality syngas.

The invention is intended to overcome or at least ameliorate these problems.

### SUMMARY OF INVENTION

There is provided, in a first aspect of the invention, an apparatus for processing a feedstock into syngas, the apparatus comprising: a fluidised bed gasifier adapted to receive the feedstock; and a free radical generator; wherein the gasifier is in fluid communication with the free radical generator such that gases and airborne char generated by the gasifier are conveyed to the free radical generator.

The term “feedstock” as used herein is intended to encompass at least “waste” and/or “residues”. The term “waste” is intended to cover a broad range of substrates which contain at least some substances which are at least partially harmful to humans. This typically encompasses all those substrates which conventionally must be sent to landfill. Typically, the waste referred to herein is rich in both hydrogen and carbon, usually containing medium and long chain hydrocarbons. Whilst the waste may be predominately organic, it may also contain inorganic matter. The waste may contain biological waste (such as food waste) or non-biological waste (such as non-recyclable plastic) or a combination of thereof. Typical wastes include municipal waste, industrial waste, commercial waste or combinations. Typically, it does not contain recyclable materials as these can often be repurposed using different techniques. Such materials are often separated from waste prior to its delivery to landfill. Often the waste will be refuse-derived fuel (RDF) waste. Often, less than 10% of the waste will be recyclable. Usually, the waste is composed of at least 50% hydrocarbons, more typically at least 70% hydrocarbons and even more typically a least 85% hydrocarbons.

The term “residues” encompasses typically unwanted materials which, whilst not generally unsafe, are nevertheless frequently sent to landfill. Some residues are deliberately manufactured or cultivated either for use as fuel or as a feedstock. Other residues are a by-product of common industrial or agrochemical processes. Typical examples of residues include, but are not limited to: algae, biomass fractions of mixed municipal waste, biomass fractions of industrial waste not fit for use in the food or feed chain, straw, animal manure, sewage sludge, palm oil mill effluent, empty palm fruit bunches, tall oil pitch, crude glycerine, bagasse, grape marcs, wine lees, nut shells, husks, cobs cleaned of kernels of corn, biomass fractions from forestry and forest-based industries (such as bark, branches, pre-commercial thinnings, leaves, needles and tree tops), saw dust, cutter shavings, black liquor, brown liquor, fibre sludge, lignin and tall oil, other non-food cellulosic material, other ligno-cellulosic material except saw logs veneer logs, used cooking oil, animal fats or combinations thereof.

The term “char” is intended to take its usual meaning in the art. That is to say, solids containing at least some carbonaceous material. Whilst the presence of oxygen and high temperatures promotes the oxidisation of such materials, often not all the feedstock is successfully oxidised. This solid carbonaceous char fraction can be categorised as “airborne” and “non-airborne” char. In the present invention, the non-airborne chars are usually too heavy to be conveyed by the gas stream generated in the gasifier and so are not sent on to the free radical generator for further processing. The airborne char is that which is swept along with the gases exiting the gasifier into subsequent components of the apparatus. Typically, the airborne char are particles with a diameter of less than 250 μm, more typically less than 200 μm, and more typically still less than 150 μm. Often, the airborne char particles have a diameter of less than 100 μm, and in some cases less than 75 μm. As one might expect, whether or not a particle is airborne also depends on the density of the particle. The smaller and lighter the particles, the more easily carried through the apparatus said particles will be. The composition of the char is not always homogeneous nor is it constant (and the geometry of particles can vary greatly). Accordingly, it may be that only 50% of particles with a diameter of 75 μm are airborne; whereas nearly 100% of particles with a size of 1 μm are airborne. The above particle size restrictions are merely a typical indication as to the size of airborne char particles for common feedstocks. As one will appreciate, a range of different particle sizes are formed. There is no particular particle size distribution but often the D₅₀ of the particles is in the range of 10 to 100 μm, more typically around 20 to 90 μm, even more typically around 30 to 50 μm and most typically around 35 to 45 μm. As will become apparent, the apparatus of the invention is operated such that char is produced even though not all of it is fully converted into syngas. As such, the char referred to herein is typically non-volatile carbon. Typically the char comprises in the range of >70% solid carbonaceous materials, more typically >85%, more typically still>95% and even more typically still>99% solid carbonaceous materials.

Among the “gases” generated in the gasifier it is common for tar to be present. The term “tar” is intended to encompass long chain hydrocarbons. Whilst the hydrocarbons will predominantly composed of only carbon and hydrogen, various heteroatoms may be present as different functional groups. The hydrocarbons may be linear, cyclic and/or aromatic and typically encompass compounds having six or more carbon atoms. At the temperatures that the gasifier of the invention is typically operated, such materials are invariably in the gaseous phase on leaving the gasifier. These tars can be broken down further in the subsequent stages of the apparatus of the invention. The tar referred to herein are typically volatile carbons and typically comprises complex hydrocarbons such as heterocyclic components (such as phenol, pyridine, etc.), aromatic components (such as benzene, xylene, styrene, toluene, etc.), or polyaromatic hydrocarbons (such as naphthalene, phenanthrene, acenaphthene, anthracene, pyrene, etc.) not fully broken down by the gasification process into hydrogen, carbon monoxide, carbon dioxide, and water vapour. Such materials are produced in the gasifier and carried along with the other gases. It is desirable to convert these more complex hydrocarbons into simpler syngas components not only to improve the efficiency of the process but because, if they are not reformed or removed from the syngas, they can cause fouling of downstream equipment.

In addition to the “char” and “tar” described above, ash is also produced in the gasifier. The term “ash” is intended to take its usual meaning in the art, that is to say, it encompasses incombustible and/or completely oxidised solid materials. The ash can be of various sizes and is often small enough to be airborne i.e. it can be carried along with the gases, char and tar exiting the gasifier. The particle size and particle size distribution of the fly ash is typically the same as that described above with respect to the airborne char. Ash can also aggregate in the gasifier and form larger non-airborne aggregates that typically become entrapped within the bed of the fluidised bed gasifier. As such, ash can be categorised as “fly” and “bottom” ash respectively. In the present invention, bottom ash is periodically removed from the gasifier bed together with any non-airborne char also collected in the fluidised bed. Fly ash is swept along with the gases exiting the gasifier into subsequent components of the apparatus. Typically, the ash comprises inorganic materials, such as metals or oxides (e.g. metal oxides). Particularly common ash materials include silica, alumina, calcia, iron oxide and combinations thereof.

For the avoidance of doubt, the term “syngas” as used herein is intended to refer predominately to a mixture of hydrogen (i.e. dihydrogen gas), carbon monoxide, carbon dioxide and water vapour. However, other ingredients may also be provided together with the syngas. For instance, fine particulate carbon may also be present in the syngas (as part of the airborne char fraction). The gases produced by the apparatus of the invention typically comprise at least 90% syngas, more often at least 95% syngas; and even more typically at least 98% syngas. Typical impurities present in the syngas include, but are not limited to: noble gases, nitrogen, ammonia, hydrogen chloride, sulphur dioxide, and hydrogen sulphide. Typically, the total amount of impurities present in the syngas is <10%, more typically <5% and often<1%.

As one skilled in the art would understand, the ratio of syngas components (i.e. the relative amounts of water vapour, carbon monoxide, carbon dioxide, and hydrogen) varies depending upon the application envisaged for said syngas. The present invention is not limited to any particular ratio. However, it is typically the case that molar ratio of hydrogen (i.e. dihydrogen gas) to carbon (i.e. carbon monoxide and carbon dioxide combined) is in the ratio of 5:1 to 1:5, more typically 3:1 to 1:3 and even more typically in the ratio of 2:1 to 1:2. Often the ratio will be approximately 2:1 (usually 2.2 to 0.8 to 1.8 to 1.2) and in some circumstances the ratio will be approximately 1:1 (usually 1.2 to 0.8 to 0.8 to 1.2). In some embodiments, it may be the case that the ratio of hydrogen to carbon monoxide to carbon dioxide (H₂:CO:CO₂) in the syngas is 30%-50%:30%-50%:10%-30%. More typically, this ratio is 35%-45%:35%-45%:15%-25%, and even more typically about 40%:about 40%:about 20%.

As one skilled in the art will appreciate, there are various different types of gasifier. The present invention makes use of a fluidised bed gasifier. For completeness, a fluidised bed gasifier comprises a reaction chamber having a layer of particulate matter at the bottom of the reaction chamber. There is no particular restriction on the choice of particulate material used in the fluid bed but it is typically made from solid particles having a high melting point (i.e. sufficient to remain solid at the temperature of the gasifier during operation) which, when an oxidising agent is injected into it, creates a fluid-like layer at the bottom of the reaction chamber (herein referred to as the “fluidised bed” or “bed”). Often, the particulate material is chemically inert i.e. it does not react with either the feedstock or the oxidising agent. Feedstock added to the gasifier contacts the fluid bed where the hydrocarbons are gasified. The oxidising agent is usually oxygen gas or air. Typical materials from which the particulate matter is made include, but are not limited to, inorganic particles, such as ceramic materials or minerals (e.g. alumino-silicate or silica). In most embodiments, the particulate material is sand.

In the present case, it may be that the oxidising agent delivered to the gasifier is substantially free of nitrogen i.e. contains less than 5% by volume, ideally less than 2.5% by volume nitrogen. Similarly, it is desirable that the oxidising agent be substantially free of noble gases i.e. contains less than 5% by volume, ideally less than 2.5% by volume. Indeed, it is often the case that the total impurities in the oxidising agent are less than 5% by volume, ideally less than 2.5% by volume. Whilst both air and oxygen are suitable, the presence of nitrogen (and other gaseous impurities) makes the resulting syngas unsuitable for certain applications, such as biofuel production. Further, whilst air can be used as a source of oxygen, this typically necessitates a larger volume gasifier to be employed. As the process is typically conducted at, or slightly below, atmospheric pressure (typically 0.5 bar to 1.2 bar, more typically 0.8 bar to 1.1 bar, more typically still 0.9 to 0.99 bar and often about 1.0 bar), it is not possible to work the same amount of oxygen into the gasifier at the same pressure unless other components of the air are removed or reduced (especially nitrogen). Therefore typically, the oxidising agent comprises at least 90% oxygen, more typically at least 95% oxygen and even more typically at least 98% oxygen.

In addition to the oxidising agent, steam may be injected into the gasifier. As one skilled in the art will appreciate, steam will react with carbon monoxide in a water gas shift reaction increasing the concentration of hydrogen and carbon dioxide in the gases exiting the gasifier. This may be desirable as the waste provided will not always possess a consistent carbon to hydrogen ratio. Typically, the steam will be delivered into the gasifier together with the oxidising agent. This not only reduces the number of inlets required in the gasifier but it improves the ease with which the gasifier can be controlled. Water vapour or steam can be pre-mixed into the oxidising agent stream depending upon the amount of water gas shift reaction required.

Moreover, the oxidising agent (and/or the steam) is typically injected into the gasifier at the bottom of the gasifier i.e. into the bed. If an oxidising agent were to be administered into the gasifier towards the top of the gasifier (i.e. in addition, or as an alternative, to injecting oxygen into the fluid bed), this would promote the breakdown of tars and airborne char materials leaving the gasifier. Whilst this may seem beneficial, it has been found that the heat produced from such exothermic reactions radiates into the gasifier and can excessively heat up the fluidised bed. Not only does this make it more difficult to control the temperature of the gasifier but it can cause the bed to fuse, reducing the efficiency of the system and, in some cases, necessitating a shut down and complete replacement of the fluidised bed material. Moreover, it also introduces the probability of higher temperature zones on the refractory lining of the gasifier. This in turn promotes the accretion of fly-ash about the gasifier's walls. This can lead to blockages and the potential for large agglomerations of ash to disengage from the walls of the gasifier that then fall into and destabilise the fluidised bed. Such events can provoke a complete system shutdown of the system. Therefore, the oxidising agent (and/or steam) is injected typically into the fluidised bed alone. This also creates the necessary low superficial velocity to maintain the bed in a fluid state. The superficial velocity of the fluidised bed is typically below 3 m/s, more typically below 1.5 m/s and even more typically below 0.8 m/s. Whilst operating the bed in this fashion does reduce the particle size of the generated ash material (i.e. results in the production of comparatively higher quantities of fly ash) and therefore means that more fly ash is present in the gas (creating a greater operational challenge downstream), it improves the overall efficiency of the system by achieving high carbon conversion efficiencies.

The combination of a fluidised bed gasifier and the free radical generator is particularly advantageous because fluidised bed gasifiers are operated at lower temperatures than conventional gasifiers (such as fixed bed gasifiers). As a consequence, although they produce a higher concentration of tars, the reformation of these tars is catalysed by free radicals created by the free radical generator. This avoids the high energetic cost of heating the gasifier to very high temperatures in order to convert a relatively small quantity of tar into syngas. Typically, the gasifier is operated temperatures less than 1000° C., more typically less than 950° C., even more typically less than 900° C., more typically still less than 850° C., and most typically in the range of 300° C. to 850° C., often 700° C. to 800° C.

As described above, operating the gasifier at a low superficial velocity means that very small quantities of non-airborne char are produced. The small quantities of non-airborne chars produced become mixed with bottom ash in the fluidised bed. Accordingly, whilst the use of a high temperature gasifier and high power post treatment processes (e.g. using plasma furnaces to gasify non-airborne char) would maximise the amount of feedstock converted into useable syngas, the energy required to convert the mixture of non-airborne chars (and any bottom ash associated therewith) into useable syngas is very high and uneconomical. Accordingly, the gasifier may typically comprise one or more outlets to permit the removal of non-airborne char and bottom ash from the gasifier. Where the gasifier is equipped with such an outlet (or outlets), accumulated non-airborne char will typically be removed periodically or continuously as desired.

Typically, the non-airborne char and bottom ash outlet will be tapped such that the gasifier may continue to operate whilst non-airborne char and bottom ash is drained from the gasifier. Often, the non-airborne char and bottom ash will mix with the material of the fluidised bed. As such, a portion of the fluidised bed may be removed together with the non-airborne char and bottom ash.

The apparatus of the invention is also typically equipped with a feedstock hopper which may be gas purged. That is to say, the feedstock hopper is capable of storing the feedstock prior to administration to the gasifier in a sealed environment and the atmosphere of the hopper can be purged. As explained above, it is often desirable in the present invention to use nitrogen-free oxidising agents, typically oxygen, in the gasifier. If the feedstock delivered to the gasifier is stored in a nitrogen-free atmosphere prior to delivery, this prevents contamination of the reaction conditions with nitrogen. Typically, the hopper is purged using carbon dioxide. Whilst a variety of different gases could be used for the purging operation, carbon dioxide brings benefits of improved safety because it acts as an effective fire suppressant for the combustible material held within the hopper. Moreover, carbon dioxide is a syngas component. The hopper may comprise a gas inlet to deliver a purging gas, such as carbon dioxide, to the hopper. The hopper may also be equipped with an outlet for gas existing the hopper during a purging operation. There is typically no need for the feedstock hopper to be a sealed container, especially where a gas heavier than air is employed.

In addition, the apparatus may also include a conveying means adapted to deliver the feedstock to the gasifier. Typically, said conveying means is a conveyor which may move the feedstock into the gasifier via a sealed environment. As explained above, it is desirable to exclude nitrogen from the gasifier's environment. Accordingly, ensuring that the conveyor is provided in a sealed environment allows the conveyor to be purged of air thereby preventing the inadvertent delivery of nitrogen to the gasifier together with the feedstock. There is no particular restriction on the type of conveyor employed, though it is typically capable of continuous delivery of feedstock to the gasifier. Moreover, it is typically a conveyor with a variable rate of delivery. The conveyor may be a belt, roller, chain, vibration or screw conveyor type system. However, typically, the conveyor will be a screw type conveyor as the screw mechanism is mechanically simple and can be made to substantially prevent gases and reaction materials from the gasifier travelling down the screw conveyor.

Typically, the conveyor communicates with the feedstock hopper and the gasifier. The rate of delivery of feedstock to the gasifier is typically in the range of 1 tonnes to 20 tonnes per hour. The gasifier typically has a volume capacity of 16,000 litres to 200 litres; more typically 10,000 litres to 500; even more typically 5,000 litres to 1,000 litres; or more typically still 3,000 litres to 2,000 litres.

It is typically the case that the gasifier is connected to the free radical generator via of a conduit. The conduit is typically shaped so that material exiting the gasifier moves in a downward trajectory towards the free radical generator. Often, the conduit includes a substantially vertical portion (typically the walls of which are inclined in the range of 70° to 110° to the horizontal, more typically 80° to 100° to the horizontal, and even more typically 85° to 95° to the horizontal). As the gases leaving the gasifier typically contain fly ash, this arrangement minimises accumulation of fly ash against the walls of the conduit. The conduit is typically thermally insulated and this is often provided by a thermally insulated refractory lining, though an external lining could also be employed. The temperature in the conduit is typically maintained within a temperature range of about 400° C. to about 1200° C., more typically about 600° C. to about 1000° C., and even more typically about 800° C. to about 900° C. It is advantageous for the temperature within the conduit to be within these ranges as it ensures that substantially all of the tars are maintained in a gaseous form, and both the tars and non-airborne chars are subjected to conditions which encourage for their break down. Moreover, the temperature is typically controlled so that the temperature within the majority of the conduit does not exceed 900° C., more typically 950° C. and even more typically 1000° C. If the entire conduit were subject to such temperatures for long periods of time, any fly ash within the gas stream would melt, promoting the accretion of fly ash about the walls of the conduit, resulting blockages. In a preferred embodiment of the invention, the conduit comprises one or more inlets for delivering an oxidising agent. The inventors have found that introducing an oxidising agent after gasification, and prior to exposure to the free radical generator, is advantageous for several reasons. Firstly, exposing hot airborne char and/or tar to oxygen promotes the breakdown of these materials without the need for directly introducing additional energy (e.g. actively heating the conduit). Secondly, in order for the free radical generator to perform optimally, the gases and airborne char material entering it must be at a much higher temperature than is employed for efficient operation of a fluidised bed gasifier. The reactions between oxidising agent, airborne chars and tars are exothermic and so increase the temperature of gases within the conduit to levels suitable for use in the free radical generator. This process approach therefore avoids excessive heating within the conduit and achieves the necessary increase in temperature before delivery of the gas stream to the free radical generator which, in turn, simplifies the operation of the free radical generator. So as to minimise excessive temperatures within the conduit, the oxidising agent inlet is typically positioned towards the end of the conduit closest to the free generator. Accordingly, the highest temperatures within the conduit are achieved nearest the free radical generator. This provides the energy necessary to maintain the comparatively lower temperatures within the conduit upstream of the oxidising agent inlets, provides the additional localised heating of gases to optimal levels immediately prior to their delivery into the plasma arc, and ensures that any adverse fly ash melting and agglomeration occurs to the point of entry into the plasma arc (which is better adapted to manage this material).

It is desirable that the gases leaving the conduit (entering the free radical generator) have a temperature of at least 900° C., more typically at least 950° C., even more typically at least 1000° C., more typically still at least 1050° C. even more typically still at least 1100° C. and often the temperature of the gases leaving the conduit are in the range of 1000° C. to 1400° C. In some embodiments, the gases leaving the conduit are in the range of 1125° C. to 1175° C., more typically about 1150° C.

It is often the case that two or more oxidising inlets are provided. Where more than one oxidising agent inlet is present, said inlets will typically be arranged about the internal wall of the conduit (at the same length along said conduit) so that, when the inlets are in operation, the flow of gases through the conduit remains substantially parallel to the direction of the conduit. For instance, where the conduit is cylindrical, inlets may be positioned an equal distance apart from one another about the internal circumference of the cylinder in a radially fashion. Typically in such arrangements, the rate of oxidising agent delivery is substantially the same for each inlet. This ensures that the gases moving through the conduit are not blown onto one internal wall of the conduit, which might promote uneven wear to the conduit or an undesirable build-up of material.

The rate of oxygen delivery to the conduit will vary depending upon the tar and airborne char composition of the gases exiting the gasifier. Moreover, the flow rate and volume of gases through the system and the need to control the temperature of the conduit also modifies the rate of oxygen delivery. However, typically the rate of delivery of oxidising agent will be equivalent to 60 kg per hour to 1,200 kg per hour of oxygen gas. The rate of delivery is also typically controlled to as to avoid an increase (or decrease) in temperature of greater than 20° C. per hour. If the conduit is permitted to heat up (or cool down) too quickly, this can cause damage to the conduit. In some embodiments, nitrogen or carbon dioxide can be delivered via the oxidising agent inlets, either alone or in combination with an oxidising agent. This can be useful to retard heating or promote cooling of the conduit, for instance prior to a system shut down. Typically, the oxidising agent inlet (or inlets) are continually cooled. The inlet may for example include a nozzle which protrudes from the internal wall of the conduit. This can heat up as a result of the exothermic processes occurring proximal to the inlet, where the oxidising agents meet the tar and airborne char materials produced by the gasifier. If the nozzle were not cooled, fly ash would collect upon it, melt, agglomerate, and clog the nozzle thereby disrupting the flow of oxidising agent into the conduit.

The free radical generator is typically a plasma furnace. As one skilled in the art will appreciate, a plasma furnace is a reaction chamber adapted to generate an electric arc therein. The reaction chamber typically comprises: a shell (i.e. the side walls and bottom surface of the chamber); a roof (which forms the top portion of the reaction chamber and which is typically removable); and in some cases a hearth (which supports the shell). The roof is generally hemispherical or frustum-like in shape. In the present invention, one or more electric arcs are typically created within the plasma furnace, usually between one or more electrodes in the roof and one or more electrodes in the shell (often in the base of the shell). This ensures that gases entering the plasma furnace encounter at least one electric arc. In the present invention, it is typically the case that the plasma furnace is operated so as to produce free radicals. In conventional plasma furnaces, the furnace is operated so that the electric arc heats up the contents. Whilst this does happen in the present invention to some extent, the plasma furnace is typically configured not to heat up the contents but predominately to generate free radicals, whilst generating sufficient heat to overcome thermal losses from the plasma furnace. The free radicals are generated from the gaseous materials entering the free radical generator being heated by the very high temperatures of the electric arc itself. Oxygen radicals created in the process in particular are effective at catalysing the breakdown tars into useful syngas components. The conditions in the free radical generator are conducive to gasifying airborne char, which then forms part of the syngas.

The fly ash entering the free radical generator may become deposited within the free radical generator (i.e. it becomes bottom ash) or may be expelled from the free radical generator with the treated gases. Accordingly, the free radical generator will typically be equipped with an outlet to permit the removal of bottom ash deposited in the free radical generator. Ash present in the plasma furnace may become molten slag due to the high temperatures within the plasma furnace. This slag can be removed, typically via an outlet at the base of the plasma furnace. Ideally, the plasma furnace is shaped so as to direct molten slag towards the outlet so that, on either a periodic or continuous basis, slag can be removed from the plasma furnace. Typically, the temperature of the free radical generator is in the range of 1000° C. to 1400° C., more typically about 1125° C. to 1175° C., and most typically about 1150° C.

Typically, the free radical generator will not comprise an oxidising agent inlet. The temperature of the free radical generator, in the case of a plasma furnace, is governed by: the temperature of gases entering the free radical generator, the energy provided to the free radical generator (e.g. the intensity of the electric arcs), and the concentration of various reactive species within the gases. If oxygen is delivered directly into the free radical generator, this can make it difficult to maintain a constant temperature as both the electric arcs and exothermic oxidising reactions contribute to an increase in temperature. Maintaining a constant temperature within the free radical generator becomes complicated in this situation, especially if the flow rate of gases through the apparatus is variable. Moreover, injecting oxygen directly into the free radical generator can cause rapid abrasion of the reaction chamber as a result of direct contact between the oxygen and syngas mixtures. Also, the presence of additional inlets in the walls of the plasma furnace (usually having a nozzle or similar protrusion) can increase the risk of side arcing. Therefore, it is preferred for no additional gases to be introduced into the free radical generator.

Often, the base of the plasma furnace will be lined with a thermally insulating material, typically a refractory material. Fly ash and other incombustible material will typically collect in the base of the plasma furnace forming a molten slag. This molten slag is typically corrosive and so can damage the base of the plasma furnace. As such, it is desirable to protect the base of the plasma furnace so as to minimise damage to the plasma furnace. In addition, the inlet to and the outlet from the plasma furnace are typically arranged so as to ensure gases remain in the plasma furnace for a sufficient length of time. Typically, gases are resident within the plasma furnace for less than 10 seconds, more typically less than 5 seconds and most typically about 3 seconds. Often, the retention time is in the range of 1 to 3 seconds. This may be achieved in a number of ways. For instance, the plasma furnace may be generally circular and the inlet may be positioned so as to guide the gases entering the plasma arc in a tangential direction. The position of the outlet may be similarly configured so that tangentially moving gases work their way into the outlet after being cycled around the plasma furnace.

The plasma furnace will typically operate at a voltage in the range of 50V to 500V of direct current, more typically 100V to 400V and even more typically, 150V to 300V. Often the voltage will be about 200V. As already mentioned, the overall electrical power in the arc will be sufficient to overcome thermal losses from the plasma furnace and to ensure that the molten slag is kept molten. Typically, this requires a power in the range of 0.1 MW to 3.0 MW, more typically 0.2 MW to 2.5 MW and most typically in the range of 0.3 MW to 2.0 MW.

In a preferred embodiment, the gases exiting the free radical generator are passed through a heat exchanger. This is typically a radiative heat exchanger that may be gas (e.g. carbon dioxide) or water cooled. The gases leaving the plasma furnace will often still comprises significant quantities of fly ash. Therefore, it is advantageous to flash cool the gases leaving the plasma furnace as this promotes the condensation of said fly ash into a friable material, easily separable from the gas stream. The heat exchanger typically reduces the temperature of the gases to less than 750° C., more typically less than 700° C., even more typically less than 650° C., and often the gases leaving the heat exchanger have a temperature in the range of 500° C. to 600° C. This temperature change is typically effected in less than 10 second, more typically less than 5 seconds, more typically still less than 4 seconds, even more typically still less than 2 seconds, and often in less than one second. The fly ash will drop to the base of the heat exchanger and is typically removed through a port for safe disposal. The gases exiting the free radical generator contain heavy metals, acid gases and reducing gases that will rapidly corrode the heat exchanger and the rapid cooling of the gas helps to protect the heat exchanger from this corrosion. Accordingly, it is desirable for the heat exchanger to have a low surface area to minimise the impact of this corrosive material on the heat exchanger.

The heat exchanger may have a further stage such that, after rapid cooling has been effected in the first heat exchange operation, a second heat exchange operation is performed to reduce the temperature of the gases to typically less than 350° C., more typically less than 300° C., more typically still, less than 250° C., and most typically in the range of 150° C. to 250° C., often about 200° C. The second heat exchange operation need not be as rapid as the first heat exchange operation. However, typically the second heat exchange operation cools the gas stream at a similar rate to the first operation i.e. typically in less than 10 second, more typically less than 5 seconds, more typically still less than 4 seconds, even more typically still less than 2 seconds, and often in less than one second. This is done so as to minimise the formation of dioxin and furan species in the gas stream which seem to form most prevalently at temperatures between 300° C. and 800° C. It simply reduces the gas temperature to more manageable levels for post processing of the syngas. Typically the heat exchanger possesses a large radiant pass section, for instance the heat exchanger may take the form of a chamber possessing walls comprising thermally conductive material, cooled by a gas or liquid jacket. Typically, a carbon dioxide jacket or water jacket is used. Often a carbon dioxide jacket is used and said carbon dioxide may be used administered into the gas stream of the process. This not only allows the carbon dioxide levels in the syngas to be balanced but permits the recycling of waste heat. Similarly, a water jacket can be used to provide a source of steam for use in the process as discussed above. Of these two, water is particularly used. The chamber may be a tube of any particular geometry (e.g. having a circular, square, pentagonal or other polygonal cross section). The tube may be sloped in a downward trajectory to encourage the flow of condensed fly ash along tube.

Alternatively, the tube may be substantially horizontal (in the range of ±20°, more typically ±10° and even more typically ±5° to the horizontal). The tube may be equipped with an outlet for condensed fly ash and/or may include a portion adapted to receive said condensed fly ash, thereby permitting its separation from the gas stream.

The apparatus of the invention may also include a fluid pump adapted draw and/or drive gas through the apparatus at a given rate. Typically, the fluid pump is a fan which is typically in fluid communication with the free radical generator and/or the gasifier. Often, the fluid pump is in fluid communication with both the free radical generator and the gasifier. Typically, the fan is an induced draft fan (ID fan). It is advantageous to position the fluid pump downstream of heat exchanger as the temperature of the gas is lower than other portions of the apparatus and includes fewest particulates and contaminants (as the majority of the fly ash will have been captured). As such, the conditions that the fluid pump is exposed to are comparatively less harmful, prolonging the life of the fluid pump. The speed of the fluid pump is typically adjustable so that the rate of flow of the volume of gas through the apparatus can be varied as required.

A filtration system may be provided, which is typically downstream of the free radical generator and more typically downstream of the heat exchanger. Often, the filtration system will be downstream of the fluid pump. Even after the free radical treatment process and the heat exchange process, it is possible that some fly ash is still present in the gases which requires filtration. As such, a fine particle filter is typically employed to remove any remaining fly ash from the gas. It is desirable to position the fluid pump upstream of the filter because, in the event that the filter becomes clogged (or partially obstructed) the pull on the upstream gases will not be hindered by a clogged filter. Typically, the fluid pump is a positive displacement pump.

The apparatus of the invention may additionally include a controller adapted to receive information indicative of one or more properties of the gas contained within the apparatus and, based on that information, modify the operation of one or more components of the apparatus in order to optimise the gas composition, yield, pressure, temperature, flow rate, energy content, rate of production of the gas or combination thereof. It is particularly advantageous for syngas to be produced at a constant rate from the apparatus. However, the gasification and treatment of a feedstock to form syngas includes many variables which cause fluctuations in the syngas composition and the rate at which said syngas is produced. Accordingly, one or more sensors are typically provided so that parameters indicative of the above properties can be measured and, based on said measurements, modifications to the apparatus' operation can be made in order to optimise output. For instance, taking the rate of gas production into consideration, the controller may be in communication with the fluid pump so as to vary the speed of the pump to ensure a substantially constant flow of syngas out of the apparatus. It is particularly preferred that at least one sensor is provided to monitor the gas produced by the system i.e. the gas downstream of the filter. In some embodiments, this is the only sensor in communication with the controller. Because the invention is capable of producing high quality syngas, the syngas does not typically need much (if any) post treatment. Accordingly, different syngas mixtures can be produced simply by changing the operational conditions of the apparatus. As such, information about the final gas composition alone is sufficient to govern the operation of each stage of the process. This reduces the number sensors needed to monitor and allow effective control of the process.

Typically, the controller governs the behaviour of at least one element of at least component within the apparatus (for example, the amount of oxidising agent administered into the gasifier or the energy imparted to the free radical generator). More typically, the controller operates at least two components of the apparatus and even more typically substantially all components of the apparatus. The controller may govern the amount of oxidising agent administered into the apparatus, e.g. into the gasifier and/or the conduit, so as to maintain the temperature of the gases within set thresholds. The controller may govern the conveyor so as to vary the rate of delivery of feedstock into the gasifier based on measurements indicative of the gas composition.

There is also provided in a second aspect of the invention, a process of making syngas from a feedstock, the process comprising: i) delivering the feedstock to a fluid bed gasifier; ii) gasifying the feedstock in the presence of a first oxidising agent to produce a gas stream and a non-airborne char; and iii) transferring the gas stream to a free radical generator.

The inventors have found that the use of a fluidised bed gasifier in conjunction with a free radical source facilitates energy efficient production of syngas. Whilst fluidised bed gasifiers do not generate a very “clean” syngas product, i.e. comparatively high volumes of tar and fly ash are produced compared to other gasifier technologies, a substantial portion of most common feedstocks can be successfully gasified and the use of free radicals downstream of the gasifier is an effective way of catalysing the breakdown of tars present in the gas stream. The net result is a very energy efficient syngas production process.

For the avoidance of doubt, those non-airborne chars and bottom ashes which are generated in the gasifier are not transferred to the free radical generator but instead remain within the gasifier. Typically, they become incorporated into the fluidised bed and are removed periodically or continuously as desired. Whilst it is less atom efficient to remove such material from the process, it is more energy efficient.

Typically, the temperature of the gasifier is as described above in relation to the first aspect of the invention, most typically in the range 700° C. to 800° C. Such temperatures provide an optimum rate of production of syngas, tar and char materials.

As explained above, the gas stream is transferred to the free radical generator via a conduit in which a second oxidising agent is added to the gas stream. Conducting an intense oxidisation process outside the gasifier has numerous advantageous in preserving good operation of the gasifier and enhancing the fidelity of control over the whole syngas production process. By introducing an oxidising agent into the conduit, typically oxygen as identified in the first aspect of the invention, it is possible to control the temperature of the gases entering the free radical generator by increasing or decreasing the rate of delivery of oxidising agent into the conduit. The reaction between the gases, tar, airborne char and the oxidising agent provides the necessary heat without requiring an additional heat source.

Typically the temperature in the conduit is as described in relation to the first aspect of the invention and often in the range 1000° C. to 1200° C. Such temperatures are optimal for promoting the catalysed tar reformation and gasification of airborne char that occur within the free radical generator.

As explained in relation to the first aspect of the invention, the process typically further comprises the step of: iv) rapidly cooling the gas stream to a temperature as described above, typically in the range of 500° C. to 600° C. The rate of cooling and the preferred temperatures are as described above.

Usually, the first and second oxidising agents (i.e. that delivered into the fluidised bed of the gasifier and that administered to the conduit between the gasifier and the free radical generator respectively) are as described above in the first aspect of the invention. Most typically each independently comprises at least 95% oxygen.

As will be apparent from the first aspect of the invention, the free radical generator is typically a plasma furnace. The furnace is operated so as to primarily produce free radicals, typically oxygen radicals, so that said radicals can promote the breakdown of airborne chars and tars. The electric arcs are not configured to reform chars or tars themselves. Accordingly, the electric energy delivered to the plasma furnace is optimised to promote the formation of free radicals, especially oxygen radicals. This is typically enough energy to maintain the temperature of the plasma furnace at the above described temperatures (mitigating heat losses) and which typically maintains condensed fly ash (i.e. bottom ash) as a molten slag at the base of the plasma furnace.

It is typically the case that the process is controlled so as to produce syngas at a constant rate. The properties of the gas may be monitored at each stage of the process and this information may be delivered to a controller. By controlling one or more of the various stages of the process, a constant stream of syngas can be produced and the composition of said syngas can be monitored and controlled in a dynamic fashion.

The process is typically carried out using the apparatus described in the first aspect of the invention. Moreover, the process is usually conducted at about atmospheric pressure. However, it may be the case that the process is conducted at slightly below atmospheric pressure (see above, for instance as low as 0.5 bar). This is preferred to ensure that any leaks in the system draw oxygen into the process so that any combustion is contain within the equipment, improving the safety of operation.

In order to aid understanding, preferred embodiments of the invention will now be described with respect to the following figures and examples.

### DESCRIPTION OF FIGURES

FIG. 1 shows a schematic diagram of a preferred apparatus of the invention.

FIG. 2 shows a schematic diagram of the conduit between the gasifier and the free radical generator.

FIG. 3 shows a schematic diagram of the heat exchanger.

### DETAILED DESCRIPTION

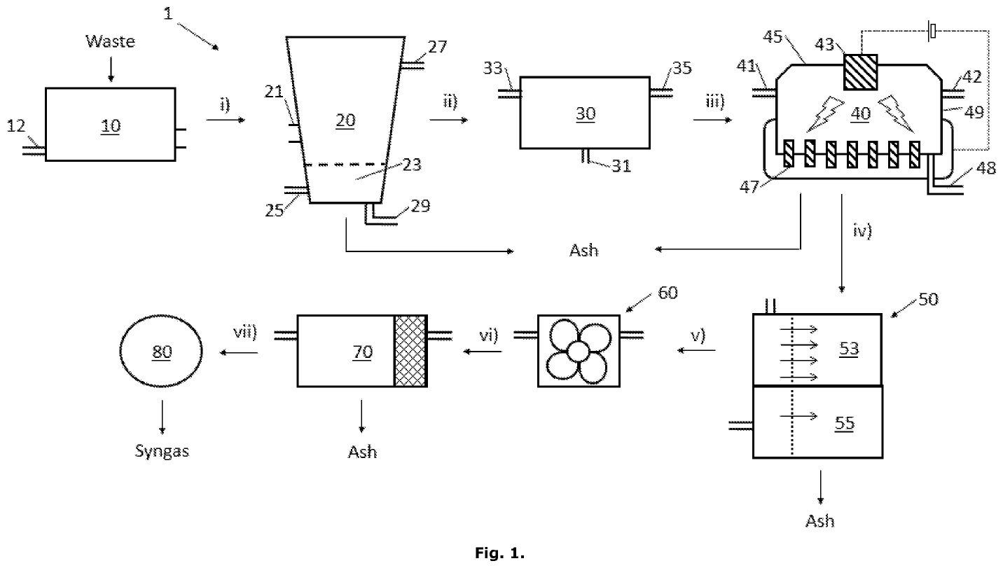

FIG. 1 shows a schematic diagram of a typical apparatus 1 of the invention. A feedstock is delivered to waste hopper 10. The feedstock hopper is not particularly limited in size but is equipped with an inlet 12 through which carbon dioxide gas can be administered during operation. The carbon dioxide displaces air present within the hopper and so purges substantially all nitrogen and oxygen contained within the hopper. A screw conveyor (not shown) transports purged waste along a sealed channel at a rate governed by the controller (not shown) to an opening 21 in the fluidised bed gasifier 20 positioned above the fluidised bed 23 such that the feedstock falls onto the fluidised bed 23. The conveyor is in communication with the controller (not shown) and the controller can adjust the rate of delivery of feedstock to the gasifier based on downstream process parameters. In particular, the rate of feed is calibrated so as to ensure a substantially consistent thermal input and production of syngas.

The gasifier 20 is a vertically aligned cylinder or cuboid with a height of 16 to 20m. It is constructed of refractory lined carbon steel. The gasifier 20 is heated to a temperature of around 800° C. and a mixture of oxygen gas and steam is injected into the gasifier 20 at the base of the gasifier via an inlet 25 so that the oxygen gas mixes with the bed 23 to create a fluid-like bed to which the feedstock is exposed. This creates a fluidised bed and the flow of oxygen and steam is controlled so as to produce a low superficial velocity. The gasified compounds produced in the gasifier, including syngas (i.e. a mixture of carbon dioxide, carbon monoxide, hydrogen and water), tars, airborne char, and fly ash exit the gasifier through outlet 27 into conduit 30. Non-airborne chars and bottom ashes are deposited in the fluidised bed and are periodically removed from the gasifier 20 via outlet 29, together with a portion of fluidised bed material (usually sand). This material is screened to remove large material (predominately non-reactive inorganic components) and the remaining material (sand and char) are returned to the gasifier for further processing. Periodically, the process will be halted and this system will be subject to blowdown where all of the material is rejected and replaced to prevent accumulation of the material in the fluidised bed.

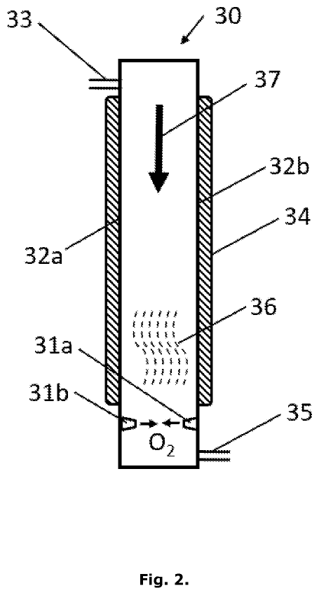

Conduit 30 includes an oxygen inlet 31. The conduit is operated so that the oxygen gas administered thereto creates a temperature in the conduit such that gases leaving via gas outlet 35 have a temperature of approximately 1150° C. As can be seen from FIG. 2, the conduit 30 is a steeply inclined shaft comprising two oxygen inlets 31a,31b, having nozzles positioned opposite one another on the side walls 32a,32b of the conduit. The conduit is provided with thermal insulation 34, though this is usually in the form of a refractory lining, so as to aid in the maintenance of a consistent temperature within the conduit (and prevent damage to the conduit). Oxygen gas is injected via the oxygen inlets 31a,31b which reacts with the gas stream to generate heat 36 which aids in the maintenance of a constant temperature within the conduit 30 upstream of the oxygen inlets 31a,31b. The gases travel down the conduit 30 in the direction 37 indicated, leaving the conduit via outlet 35. The oxygen inlets 31a,31b include nozzles made from a robust metal material such an austenitic nickel-chromium-based superalloy e.g. Inconel (RTM).

The gases exiting conduit 30 are delivered to the plasma furnace 40 via a gas inlet 41. The plasma furnace includes a first electrode 43 positioned in the roof 45 of the plasma furnace and a plurality of second electrodes 47 in the base of the shell 49 of the plasma furnace. During operation, an electric arc is generated between the electrodes 43,47. The electric arcs generate high energies that result in the formation of free radicals. The oxygen free radicals formed are particularly effective at breaking down tars. Some fly ash accumulates in the base of the plasma furnace. This material can be removed either continuously or periodically using outlet 48. Some fly ash is transported with the gases exiting the plasma furnace. The location of the inlet and outlet of the plasma furnace are chosen to provide a residence time for the gases, tars and airborne char of about 3 seconds. This provides sufficient time for tar reformation, gasification of the airborne char and capture of fly ash. This is achieved by injecting the gas tangentially in order to create a circular flow around the furnace. The tangential injection promotes the motion of larger particles, such as fly-ash, towards the walls of the system which improves the likelihood that they will be captured. The plasma furnace 40 is cylindrical with the inlet port 41 located tangentially at one side and the outlet port 42 located either at the top or tangentially at the opposite side. The plasma furnace is made of refractory lined carbon steel. The outlet duct from the furnace is angled steeply upward to meet the waste heat boiler. The duct is constructed from refractory lined steel. It should be kept as short as possible to avoid fouling by fly-ash.

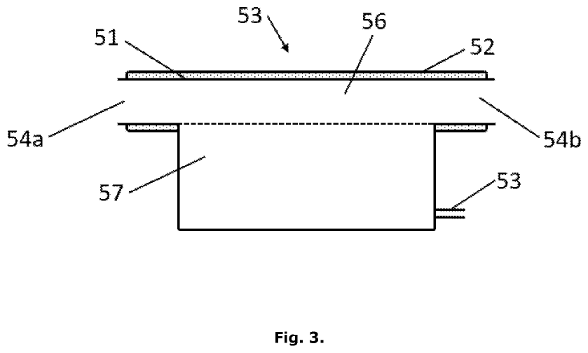

Gas exiting from the plasma furnace 40 is delivered to the waste heat boiler 50. The boiler comprises a first heat exchanger 53 and a further heat exchanger 55. The first heat exchanger rapidly cools the gases existing the plasma furnace to below 600° C. FIG. 3 shows a schematic view of a preferred embodiment of the first heat exchanger 53. The heat exchanger 53 is a horizontal carbon steel tube having walls 51 surrounded by a water jacket 52. The syngas enters via the inlet 54a, moves along the lumen 56 of the tube and is radiatively cooled by the walls 51 of the tube. Fly ash drops out into an ash box 57. Ash can be removed from the ash box 57 using a rotary valve 53. Syngas comprising a reduced fly ash content then leaves via outlet 54b. The second (and optionally third stage) heat exchanger comprises a set of horizontally mounted carbon steel fire tubes passing through the same cooling water system as the first heat exchanger. The gas is convectively cooled in these exchangers. Around 25% of the water in the cooling system is fed back to the gasifier and 75% is available for export to use in drying the feedstock, use in water gas shift reactions downstream or production of power.

Downstream of the boiler, there is provided an induced draft fan 60 configured to draw gases from the boiler and maintain the rate of flow of through the apparatus. The fan can be operated at a variable speed and is controlled by the controller (not shown). The fan will typically draw the gas at a rate of 15 m/s and will maintain a pressure in the upstream equipment of −5 mbar below atmospheric. The fan is also made from a robust metallic material such an austenitic nickel-chromium-based superalloy e.g. Inconel (RTM). As will be appreciated, the fan must endure harsh conditions and so must be hard wearing.

The filtration system is a dry gas filter, usually a carbon steel inverted pyramid containing ceramic filter elements through which the syngas is drawn to remove any remaining fly ash. The system is periodically flushed with carbon dioxide to knock ash from the filters into a collection bin at the base of the unit.

Downstream of the fine particulate filtration system is a measuring unit 80 which monitors various properties of the syngas. These include: temperature, composition, energy content, rate of flow and pressure. The measuring unit communicates this information to a controller which in turn, adapts the behaviour of the various components of the system so as to ensure a regular flow of syngas out from the apparatus. It is not easy to make detailed measurements of the syngas before this point because tars and fly ash would damage the measurement equipment. Therefore, it is typical for the control system to infer the composition and quality of the syngas in earlier stages of the process based upon measurements taken by the measuring unit 80 at the end of the process.

The calorific value and flow rate of the syngas are combined to calculate the thermal output from the process. The thermal output is used to modulate the feedstock addition rate to the gasifier. The flow rate, temperature and pressure from the system are monitored and will reduce the thermal output set point to ensure the gas flows are within tolerable limits for the equipment. The gas composition is monitored to determine if the gasification of feedstocks is proceeding properly. Each of these methods typically involves a dedicated algorithm using upstream temperatures, pressures and flows to estimate gas stream properties and to respond with a suitable modification of the apparatus' operation in order to a achieve a desired outcome.

1. An apparatus for processing a feedstock into syngas, the apparatus comprising:
a fluidised bed gasifier adapted to receive a feedstock; and
a free radical generator;
wherein the gasifier is in fluid communication with the free radical generator such that gases and airborne char generated by the gasifier are conveyed to the free radical generator;
wherein the gasifier comprises one or more outlets to permit the removal of non-airborne char from the apparatus; and wherein the fluid communication between the gasifier and the free radical generator is provided by a conduit, said conduit containing at least one oxidising agent inlet.

2. (canceled)

3. The apparatus of claim 1, wherein the free radical generator is a plasma furnace.

4. The apparatus of claim 1, wherein the free radical generator comprises one or more outlets to permit the removal of ash.

5. The apparatus of claim 1, further comprising a feedstock hopper for storing the feedstock prior to delivery to the gasifier, wherein the hopper is gas purgeable.

6. The apparatus of claim 1, further comprising a conveyor adapted to deliver the feedstock from the feedstock hopper to the gasifier.

7. The apparatus of claim 1, wherein the gasifier comprises a fluid bed and an inlet for delivering an oxidising agent to the fluid bed.

8. The apparatus of claim 7, wherein the oxidising agent is oxygen.

9. (canceled)

10. The apparatus of claim 1, further comprising a heat exchanger adapted to cool gas material exiting the free radical generator.

11. The apparatus of claim 1, further comprising a fluid pumping means adapted to control the flow of gas through the apparatus.

12. The apparatus of claim 1, further comprising a controller configured to receive one or more inputs indicative of one or more variables of the syngas production process; and, based on said input, control one or more components of the apparatus so as to ensure a constant rate of production of syngas.

13. A process of making syngas from a feedstock, the process comprising:
i) delivering the feedstock to a fluid bed gasifier;
ii) gasifying the waste in the presence of a first oxidising agent to produce a non-airborne char and a gas stream, the gas stream comprising a syngas and an airborne char; and
iii) transferring the gas stream to a free radical generator, wherein the gas stream is transferred to the free radical generator via a conduit in which a second oxidising agent is added to the gas stream; wherein non-airborne chars and bottom ashes generated in the gasifier are not transferred to the free radical generator.

14. The process of claim 13, wherein the temperature of the gasifier is in the range 600° C. to 700° C.

15. (canceled)

16. The process of claim 13, wherein the temperature in the conduit is in the range 1000° C. to 1200° C.

17. The process of claim 13, further comprising the step of:
iv) rapidly cooling the gas stream to a temperature of less than 600° C.

18. The process of claim 13, wherein the first and second oxidising agents each independently comprise at least 90% oxygen.

19. The process of claim 13, wherein the free radical generator is a plasma furnace.

20. The process of claim 13, wherein the process is controlled to produce syngas at a constant rate.

21. (canceled)

22. The process of claim 13, wherein the process is conducted at or below atmospheric pressure.
